(19) United States
(12) Patent Application Publication
(10) Pub. No.: US 2013/0226789 A1
(43) Pub. Date: Aug. 29, 2013

(54) EMAIL CLIENT MONEY EXCHANGE INTERFACE

(71) Applicants: Cory Moreira, (US); Andrew Peret, (US)

(72) Inventors: Cory Moreira, (US); Andrew Peret, (US)

(73) Assignee: SERVE VIRTUAL ENTERPRISES, INC., St. Petersburg, FL (US)

(21) Appl. No.: 13/408,074

(22) Filed: Feb. 29, 2012

(51) Int. Cl. G06Q 20/10

(52) U.S. Cl. 705/39

(57) ABSTRACT

Techniques for enabling a user of the email client application to exchange messages related to online transaction accounts are disclosed. An email client application may display a transaction account interface that enables a user of the email client application to send specialized messages related to the user's online transaction account. For example, the specialized messages may include money transfer instructions, money request instructions, and referral messages.

### BACKGROUND

Email messages have become a part of everyday life. People use email messages to communicate with a wide variety of people for a wide variety of purposes. Because people use email messages so frequently, people are accustomed to using email client applications that enable people to send and receive email messages. For instance, many people have become accustomed to using email client applications such as Microsoft Outlook™ from Microsoft Corporation of Redmond, Wash., Thunderbird from the Mozilla Corporation of Mountain View, Calif., and Lotus Notes™ from International Business Machines of Armonk, N.Y.

Recently, several major providers of email client applications have added capabilities to their email client applications that enable third party developers to create toolbars and other interfaces that appear within the user interfaces of the email client applications. Such toolbars may enable end users to send specialized types of email messages using the email client applications or to interact with email client applications in customized ways. For example, a toolbar may include icons that, when selected, automatically insert standardized text into email messages.

### SUMMARY

In general, this disclosure describes techniques for enabling a user of an email client application to exchange messages related to online transaction accounts. In various embodiments, the email client application may display a transaction account interface that enables a user of the email client application to send specialized messages related to the user's online transaction account. For example, in various embodiments specialized messages may include money transfer instructions, money request instructions, and referral messages.

The techniques of this disclosure may be conceptualized in a many ways. For example, the techniques of this disclosure may be conceptualized as a method that comprises displaying a transaction account interface in a user interface of an email client application used by a first party who has a first online transaction account provided by a transaction service provider. The method also comprises receiving input from a user via the transaction account interface to send money from the first online transaction account to a second online transaction account provided the transaction service provider.

In various embodiments, a computer-readable storage medium comprises a first set of instructions that, when executed at a first computer system, cause the first computer system to transfer to a second computer system a second set of instructions that, when processed at the second computer system, cause the second computer system to display a transaction account interface in a user interface of an email client application used by a first party who has an online transaction account provided by a transaction service provider. The second set of instructions also causes the second computer system to in response to receiving the send money event, automatically identify a first set of parties, the first set of parties including parties in a contact list associated with the email client application that have online transaction accounts provided by the transaction service provider. In addition, the second set of instructions causes the second computer system to present a list of parties in the first set of parties. Furthermore, the second set of instructions causes the second computer system to receive a send money event on the transaction account interface. In various embodiments, the second set of instructions causes the second computer system to, after receiving the send money event, receive a recipient selection event that indicates a second party who is in the first set of parties. Furthermore, the second set of instructions causes the second computer system to send a money transfer instruction to the transaction service provider, the money transfer instruction instructing the transaction service provider to electronically transfer money from the online transaction account of the first party to the online transaction account of the second party.

In various embodiments, a device comprising an email client application that presents a user interface to a first party who has an online transaction account provided by a transaction service provider. The device also comprises a contact list that includes contact information for a plurality of parties. In addition, the device comprises a transaction interface module configured to interact with the email client application to display a transaction account interface within the user interface presented by the email client application. Furthermore, the device comprises a send money module that automatically identifies a first set of parties, the first set of parties including parties in the plurality of parties included in the contact list that have online transaction accounts provided by the transaction service provider. The send money module is configured to present a list of the parties in the first set of parties. The send money module is configured to receive a recipient selection event that indicates a second party who is in the first set of parties. In addition, the send money module is configured to send a money transfer instruction to the transaction service provider, the money transfer instruction instructing the transaction service provider to electronically transfer money from the online transaction account of the first party to the online transaction account of the second party.

### BRIEF DESCRIPTION OF THE DRAWINGS

FIG. 1 is a block diagram illustrating an example system, in accordance with various embodiments.

FIG. 2 is a block diagram illustrating example details of a client device in the system of FIG. 1, in accordance with various embodiments.

FIG. 3 is a flowchart illustrating an example operation of a transaction interface module, in accordance with various embodiments.

FIG. 4 is a flowchart illustrating an example operation of a send money module, in accordance with various embodiments.

FIG. 5 is a flowchart illustrating an example operation of a request money module, in accordance with various embodiments.

FIG. 6 is a flowchart illustrating an example operation of a referral module, in accordance with various embodiments.

### DETAILED DESCRIPTION

The detailed description of exemplary embodiments herein makes reference to the accompanying drawings and pictures, which show the exemplary embodiment by way of illustration. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers.

In various embodiments, the server may include application servers (e.g. WEB SPHERE, WEB LOGIC, JBOSS). In various embodiments, the server may include web servers (e.g. APACHE, IIS, GWS, SUN JAVA SYSTEM WEB SERVER).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. A web-client may run Microsoft Internet Explorer, Mozilla Firefox, Google Chrome, Apple Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows NT, 95/98/2000/CE/Mobile, OS2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of the various systems of this disclosure may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, the Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAI-H RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

As used herein, “issue a debit”, “debit” or “debiting” refers to either causing the debiting of a stored value or prepaid card-type financial account, or causing the charging of a credit or charge card-type financial account, as applicable.

Phrases and terms similar to an “item” may include any good, service, information, experience, data, content, access, rental, lease, contribution, account, credit, debit, benefit, right, reward, points, coupons, credits, monetary equivalent, anything of value, something of minimal or no value, monetary value, non-monetary value and/or the like.

Phrases and terms similar to an “entity” may include any individual, consumer, customer, group, business, organization, government entity, transaction account issuer or processor (e.g., credit, charge, etc), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account. The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

Phrases and terms similar to “transaction account” may include any account that may be used to facilitate a financial transaction.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

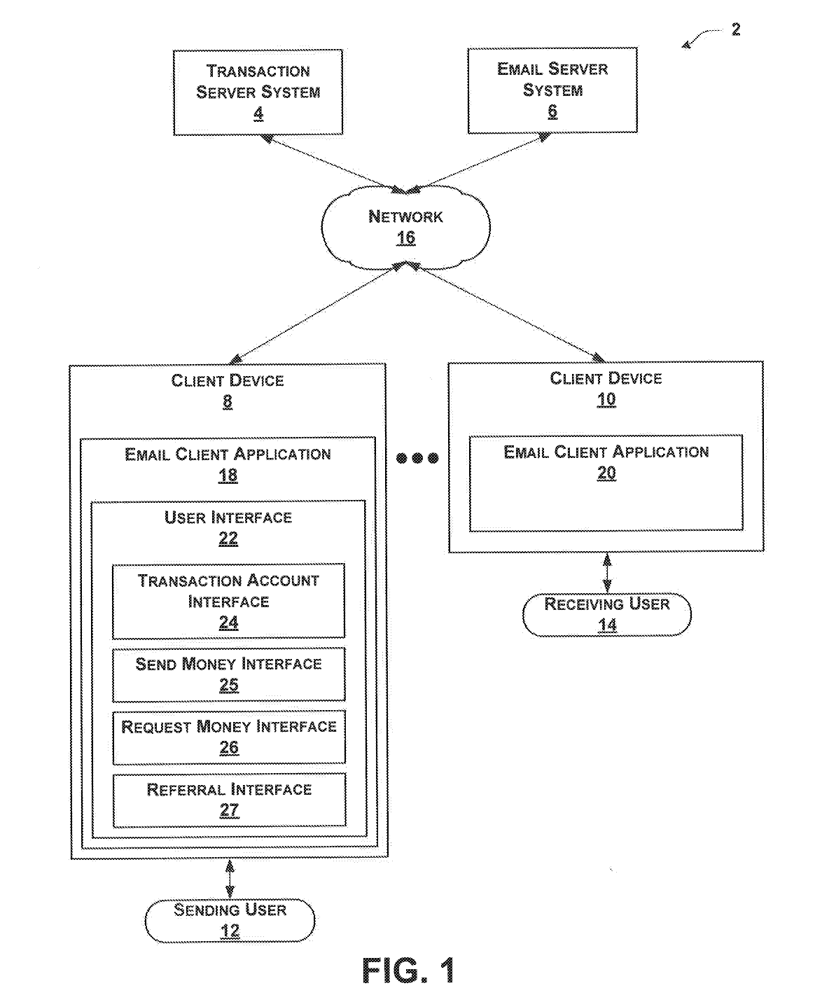

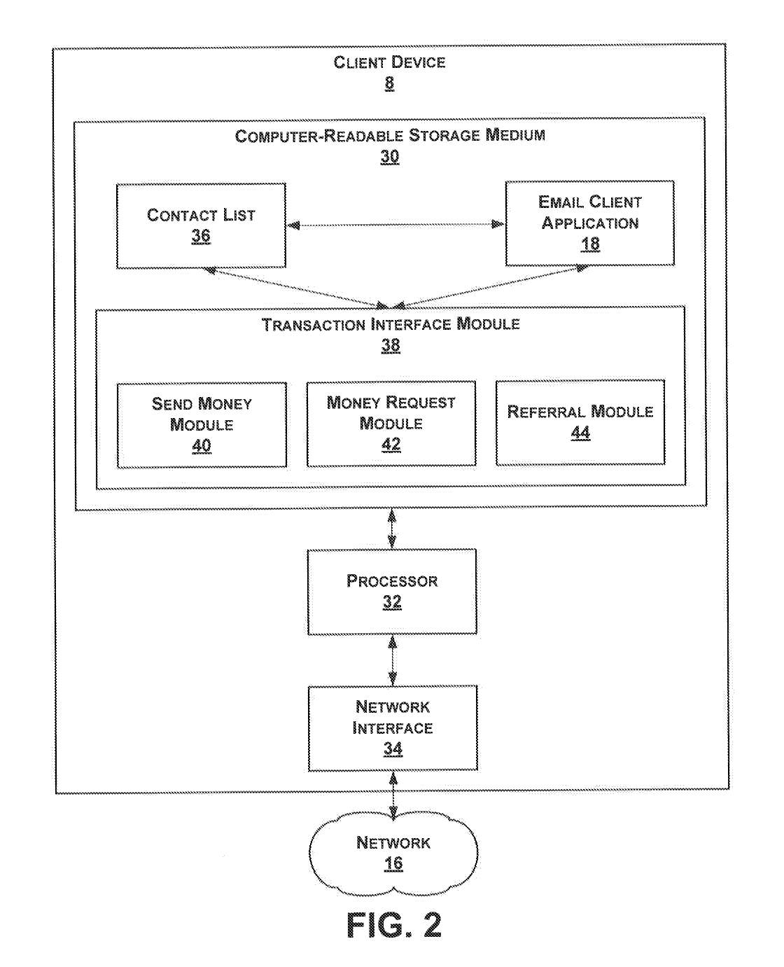

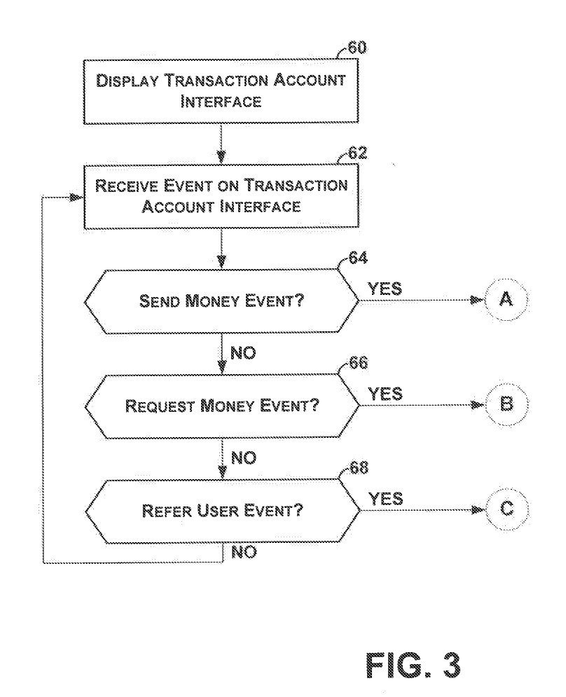

Referring now to FIGS. 3-6 the process flows and screenshots depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements depicted in FIGS. 3-6, but also to the various system components as described above with reference to FIGS. 1-2.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

FIG. 1 is a block diagram illustrating an example system 2. It should be appreciated that system 2 is an example system and is not intended to represent the only possible environment in which the techniques of this disclosure are applicable. The techniques of this disclosure may be applied in many different environments. For instance, the techniques of this disclosure may be applied in systems with more or fewer components than are illustrated in FIG. 1.

In the example of FIG. 1, system 2 comprises a transaction server system 4 operated by a transaction service provider that provides online transaction services. Details of the online transaction services are provided in detail below. Transaction server system 4 may be implemented in a wide variety of ways. For instance, transaction server system 4 may be implemented as a standalone server that executes software that causes the server to provide the online transaction services. In a second instance, transaction server system 4 may be implemented as a cluster of computers that collectively provide the online transaction services. A cluster of computers may operate as a single logical server that provides the online transaction services.

System 2 also comprises an email server system 6 that provides email services. For example, email server system 6 may operate a Microsoft Exchange Server email server, a Post Office Protocol 3 (POP3) email server, an Internet Message Access Protocol (IMAP) email server, or another type of email server. Email server system 6 may be implemented in a wide variety of ways. For instance, email server system 6 may be implemented in any of the example ways for implementing transaction server system 4 described above.

In addition to transaction server system 4 and email server system 6, system 2 includes a client device 8 and a client device 10 that act as clients of transaction server system 4 and email server system 6. Client device 8 and client device 10 may be implemented in a variety of ways. For example, client device 8 and/or client device 10 may be implemented as a personal computer, a mainframe computer, a television set top box, a mobile telephone, a network telephone, a personal digital assistant, a portable media player, a home media player, a device integrated into a vehicle, a network kiosk, or another type of device. In another example, client device 8 and/or client device 10 may be a logical device that comprises one or more computing devices of the same or different types.

In embodiments like the example of FIG. 1, a sending user 12 uses client device 8 and a receiving user 14 uses client device 10. Sending user 12 and/or receiving user 14 may be individual natural people. In various embodiments, sending user 12 and/or receiving user 14 may be logical people, such as business organizations, non-profit organizations, governmental organizations, educational organizations, political organizations, international organizations, or other types of entities that can, at least in some circumstances, logically act like natural people.

A network 16 in system 2 facilitates communication between transaction server system 4, email server system 6, client device 8, and client device 10. Network 16 may include one or more types of network. For instance, network 16 may include a local area network, a wide area network (e.g., the Internet), a global area network, a metropolitan area network, a public switched telephone network, and/or another type of network. Network 16 may include many network devices and many network links. The network devices in network 16 may include bridges, hubs, switches, firewalls, routers, load balancers, and other types of network devices. The network links in network 16 may include wired links (e.g., coaxial cable, fiber optic cable, 10BASE-T cable, 100BASE-TX cable, etc.) and may include wireless links (e.g., WiFi links, WiMax links, wireless broadband links, mobile telephone links, Bluetooth links, infrared links, etc.).

Transaction server system 4 provides a set of online transaction accounts for users. As used in this disclosure, an “online transaction account” is an account that stores money for a user. A user (e.g., sending user 12) can transfer money into the user's online transaction account from the user's conventional bank account. In addition, the user can transfer money out of the user's online transaction account into the user's conventional bank account. Furthermore, the user can easily transfer money from the user's online transaction account to another user's online transaction account. Because such a transfer occurs between online transaction accounts, neither user discloses information about their conventional bank accounts to the other user. This may reduce the possibility of identity theft and thereby encourage people to transfer money online instead of exchanging paper checks or cash.

As illustrated in the example of FIG. 1, an email client application 18 operates on client device 8 and an email client application 20 operates on client device 10. Email client application 18 and email client application 20 may be a variety of different types of email client applications. For example, email client application 18 and/or email client application 20 may be software applications executing natively on client device 8 and client device 10. In this example, email client applications 18 and/or email client application 20 may be a variety of commercially available email client applications such as Microsoft Outlook, Microsoft Outlook Express, Microsoft Windows Mail, Microsoft Windows Live Mail, Mozilla Thunderbird, IBM Lotus Notes, or other types of email client applications that operate natively on a client device. In a second example, email client application 18 and/or email client application 20 may be a web application presented by client device 8 and/or client device 10. For instance, email client application 18 and/or email client application 20 may be implemented as an Outlook Web Access email client application from Microsoft Corporation. In this second example, email client application 18 and/or email client application 20 may operate within the context of a web browser application.

Regardless of how email client application 18 is implemented, email client application 18 may display a user interface 22 to sending user 12. User interface 22 may include conventional features such as a list of email messages received, an icon for creating new email messages, an icon to create a reply message to a received email message, an icon for printing a received email message, and other types of conventional features associated with the sending and receiving of email messages.

In addition to the conventional features, user interface 22 displayed by email client application 18 includes a transaction account interface 24. Transaction account interface 24 may be implemented in many ways. For example, transaction account interface 24 may be implemented as a toolbar within user interface 22 displayed by email client application 18.

Sending user 12 may interact with transaction account interface 24 to perform a variety of actions relating to an online transaction account of sending user 12. For instance, sending user 12 may interact with transaction account interface 24 to open a send money interface 25 to send a money transfer instruction to transaction server system 4. The money transfer instruction instructs transaction server 4 to electronically transfer money from the online transaction account of sending user 12 to an online transaction account of a receiving user (e.g., receiving user 14). In a second instance, sending user 12 may interact with transaction account interface 24 to open a request money interface 26 to send a money request instruction to a receiving user (e.g., receiving user 14). The money request instruction invites the receiving user to send a money transfer instruction to transaction server system 4. This money transfer instruction instructs transaction server system 4 to electronically transfer money from the online transaction account of the receiving user to the online transaction account of sending user 12. In a third instance, sending user 12 may interact with transaction account interface 24 to open a referral interface 27 to send a referral message to a receiving user (e.g., receiving user 14) who does not have an online transaction account provided by the transaction service provider. The referral message invites the receiving user to register for an online transaction account provided by the transaction service provider.

FIG. 2 is a block diagram illustrating example details of client device 8 in the system of FIG. 1. In the example of FIG. 2, email client application 18 operates natively on client device 8.

As illustrated in the example of FIG. 2, client device 8 comprises a computer-readable storage medium 30. Computer-readable storage medium 30 may include one or more computer-readable storage media on one or more computing devices. Example types of computer-readable storage media include, but are not limited to: Random Access Memory (RAM), Read-Only Memory (ROM), Electrically-Erasable Programmable Read-Only Memory (EEPROM), flash memory, or other memory technology, CD-ROM, digital versatile discs (DVD) or other optical storage, magnetic cassettes, magnetic tape, magnetic disk storage or other magnetic storage devices, or any other types of media which can be used to store the desired information and which can be accessed by client device 8.

Furthermore, as illustrated in the example of FIG. 2, client device 8 comprises a processor 32. Processor 32 may comprise one or more microprocessors or processing cores on one or more computing devices. Processor 32 accesses data and instructions stored in computer-readable storage medium 30. When processor 32 accesses instructions stored in computer-readable storage medium 30, processor 32 may execute the instructions.

Client device 8 also includes a network interface 34. Network interface 34 enables client device 8 to communicate via network 16. Network interface 34 may comprise one or more physical network interfaces. For instance, network interface 34 may comprise one or more Ethernet cards, fiber optic interface cards, T1 line cards, wireless network interfaces, or other types of physical network interfaces. Processor 32 can send data to network interface 34 for transmission on network 16. Furthermore, network interface 34 can send data from network 16 to processor 32.

As illustrated in the example of FIG. 2, computer-readable storage medium 30 includes email client application 18. Computer-readable storage medium 30 comprises a contact list 36 which, in various embodiments, may be associated with email client application 18. Contact list 36 includes contact information for one or more parties. The contact information may include a variety of different types of information for a party. For instance, contact list 36 may include an email address for a party, an office telephone number for the party, a home telephone number for the party, a mobile telephone number for the party, an office mailing address for the party, a home address for the party, and other types of contact information for the party.

Furthermore, computer-readable storage medium 30 comprises a transaction interface module 38. In general, transaction interface module 38 interacts with email client application 18 and contact list 36 to perform actions related to the online transaction account of sending user 12. For example, email client application 18 may be configured to load transaction interface module 38 when email client application 18 starts. In various embodiments, email client application 18 loads transaction interface module 38 and transaction interface module 38 may present transaction account interface 24 in user interface 22 of email client application 18. In various embodiments, transaction account interface 24 may be a toolbar that contains icons associated with actions related to the online transaction account of sending user 12.

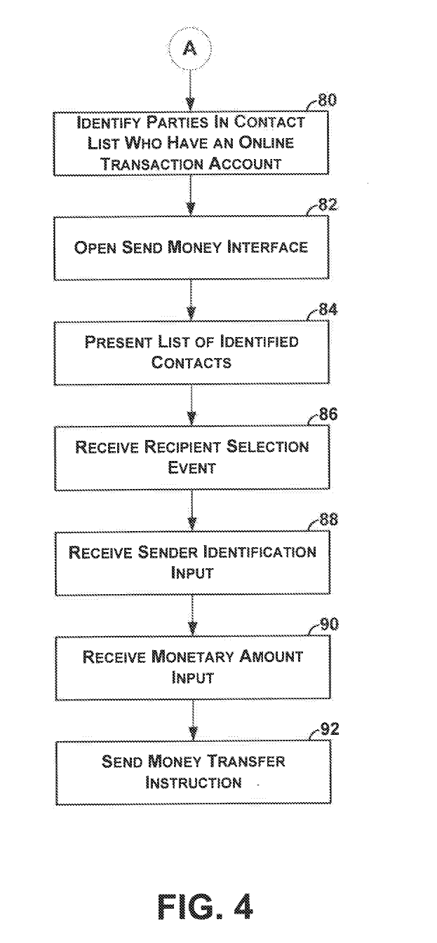

In the example of FIG. 2, transaction interface module 38 includes a send money module 40, a money request module 42, and a referral module 44. In general, send money module 40 enables email client application 18 to send money transfer instructions. Money request module 42 enables email client application 18 to send money request messages. Referral module 44 enables email client application 18 to send referral messages. Detailed descriptions of the functionality of send money module 40, money request module 42, and referral module 44 are explained below with reference to FIGS. 4-6.

FIG. 3 is a flowchart illustrating an example operation of transaction interface module 38 operating at client device 8 of FIG. 2. Transaction interface module 38 interacts with email client application 18 to display transaction account interface 24 in user interface 22 of email client application 18 (60).

Transaction interface module 38 may receive an event on transaction account interface 24 (62). The event may, for example, be caused by sending user 12 clicking on one of the icons in transaction account interface 24.

Transaction interface module 38 determines whether the event is a send money event (64). The event, for instance, may be a send money event in response to sending user 12 clicking on a send money icon in transaction account interface 24. If the event is a send money event (e.g., “YES” of 64), send money module 40 may perform the example operation illustrated in FIG. 4.

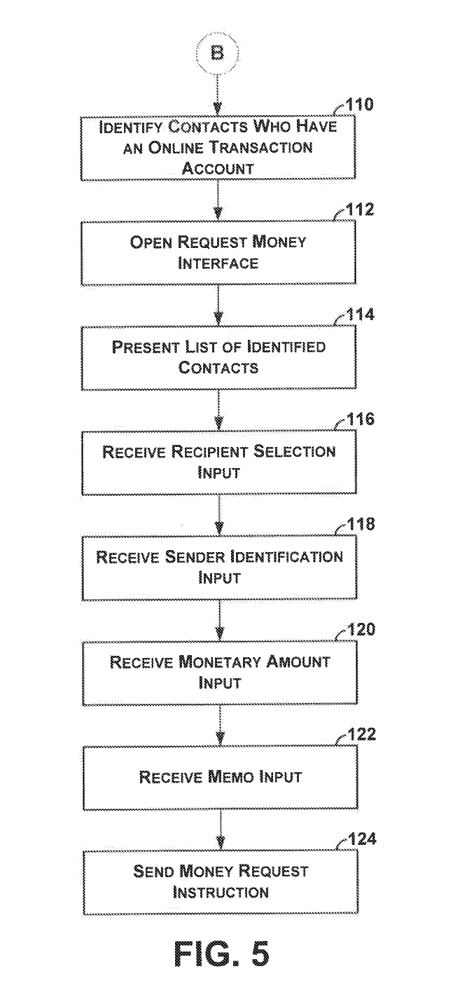

If the event is not a send money event (e.g., “NO” of 64), transaction interface module 38 determines whether the event is a money request event (66). The event, for instance, may be a request money event in response to sending user 12 clicking on a request money icon in transaction account interface 24. In various embodiments, if the event is a money request event (e.g., “YES” of 66), money request module 42 may perform the example operation illustrated in FIG. 5.

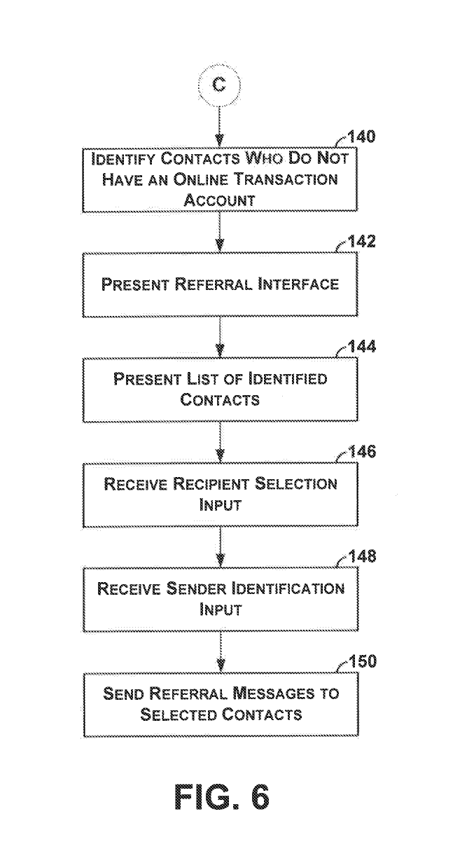

In various embodiments, if the event is not a money request event (e.g., “NO” of 66), transaction interface module 38 determines whether the event is a refer user event (68). The event, for instance, may be a refer user event in response to sending user 12 clicking on a refer user icon in transaction account interface 24. In various embodiments, if the event is a refer user event (e.g, “YES” of 68), referral module 44 may perform the example operation illustrated in FIG. 6.

In various embodiments, for instance the example shown in FIG. 3, if the event is not a refer user event (“NO” of 68), transaction interface module 38 may ignore the event and loop back to receive another event (62). It should be understood that the example operation illustrated in FIG. 3 is an example. Other operations of transaction interface module 38 may include more or fewer steps, or may perform the steps in a different order.

FIG. 4 is a flowchart illustrating an example operation of send money module 40 in transaction interface module 38 of FIG. 2. In various embodiments, transaction interface module 38 receives a send money event on transaction account interface 24, send money module 40 identifies parties in contact list 36 who have online transaction accounts provided by the transaction service provider (80). Send money module 40 may identify parties in contact list 36 who have online transaction accounts in a variety of ways. For example, transaction server system 4 may maintain a list of email addresses of parties that have online transaction accounts. In this example, send money module 40 may identify parties in contact list 36 who have online transaction accounts by comparing the email addresses of the parties in contact list 36 with the email addresses in the list of email addresses maintained by transaction server system 4. In another example, each entry in contact list 36 may include a field that indicates whether a party associated with the entry has an online transaction account provided by the transaction service provider. In this example, the field may be set manually or automatically.

Send money module identifies parties in contact list 36 who have online transaction accounts provided by the transaction service provider, send money module 40 opens send money interface 25 (82). Send money module 40 may present send money interface 25 in a variety of ways. For instance, send money module 40 may present send money interface 25 as a new window. In various embodiments, send money module 40 may present send money interface 25 within the body of a new email message.

Send money module 40 opens send money interface 25 and presents a list of the identified contacts who have online transaction accounts provided by the transaction service provider (84). Send money module 40 may present the list of the identified contacts within send money interface 25.

Send money module 40 receives, via send money interface 25, a recipient selection input that indicates one of the parties on the list of the identified contacts (86). For example, the recipient selection input may indicate receiving user 14. Throughout the remainder of the discussion of the example illustrated in FIG. 4, it is assumed that the recipient selection input indicates receiving user 14. The recipient selection input may result from a variety of actions by sending user 12. For instance, the recipient selection input may constitute a mouse click by sending user 12 on one of the parties who have online transaction accounts.

In various embodiments, send money module 40 may receive a sender identification input via send money interface 25 (88). The sender identification input may specify a personal identification number (“PIN”) of sending user 12, an account number of sending user 12, and other information that reliably indicates the identity of sending user 12.

Send money module 40 may also receive a monetary amount input via send money interface 25 (90). The monetary amount input indicates an amount of money that sending user 12 wants to send to receiving user 14.

In various embodiments, send money module 40 receives the monetary amount inputs and sends a money transfer instruction to transaction server system 4 (92). The money transfer instruction instructs the transaction service provider to electronically transfer money from the online transaction account of sending user 12 to the online transaction account of receiving user 14. The money transfer instruction may specify the sender identification input, the recipient selection input, and the monetary amount input.

Transaction server system 4 receives the money transfer instruction and may verify the sender identification input. In various embodiments, transaction server system 4 successfully verifies the sender identification input, transaction server 4 determines whether the amount of money in the online transaction account of sending user 12 is greater than the amount of money specified by the monetary amount input. If transaction server system 4 determines that the amount of money in the online transaction account of sending user 12 is greater than the amount of money specified by the monetary amount input, transaction server system 4 electronically transfers the amount of money specified by the monetary amount input to the online transaction account of receiving user 14.

FIG. 5 is a flowchart illustrating an example operation of request money module 42 in transaction interface module 38 of FIG. 2. In various embodiments, transaction interface module 38 receives a request money event on transaction account interface 24, request money module 42 identifies parties in contact list 36 who have online transaction accounts provided by the transaction service provider (110). Request money module 42 and send money module 40 may identify the parties in contact list 36 in similar or dissimilar ways.

Request money module identifies parties in contact list 35 who have online transaction accounts provided by the transaction service provider and presents request money interface 26 (112). Request money module 42 may present request money interface 26 in a variety of ways. For instance, request money module 42 may present request money interface 26 as a new window and/or request money module 42 may present request money interface 26 within the body of a new email message.

Request money module 42 presents request money interface 26 and presents a list of the identified contacts who have online transaction accounts provided by the transaction service provider (114). Request money module 42 may present the list of the identified contacts within request money interface 26.

In various embodiments, request money module 42 receives via request money interface 26 a recipient selection input that indicates one of the parties on the list of the identified contacts (116). For example, recipient selection input may indicate receiving user 14. Throughout the remainder of the discussion of FIG. 5, it is assumed that the recipient selection input indicates receiving user 14. The recipient selection input may result from a variety of actions by sending user 12. For instance, the recipient selection input may constitute a mouse click by sending user 12 on one of the parties on the list of the identified contacts.

In various embodiments, request money module 42 may receive a sender identification input via request money interface 26 (118). The sender identification input may specify information that reliably indicates the identity of sending user 12. For example, the sender identification input may specify a public key certificate issued by the transaction service provider to sending user 12.

Request money module 42 may also receive a monetary amount input via request money interface 26 (120). The monetary amount input indicates an amount of money that sending user 12 is requesting from receiving user 14.

In various embodiments, request money module 42 may receive memo input via request money interface 26 (122). The memo input may represent an explanation why sending user 12 is requesting the money from receiving user 14.

Request money module 42 receives the monetary amount input and sends a money request instruction to receiving user 14 (122). The money request instruction may include the sender identification input, the monetary amount input, and the memo input. The money request instruction invites receiving user 14 to send a money transfer instruction to the transaction service provider. This money transfer instruction instructs the transaction service provider to electronically transfer the amount of money specified by the monetary amount input from the online transaction account of receiving user 14 to the online transaction account of sending user 12.

In various embodiments, the money request instruction may be implemented in many ways. For example, the money request instruction may be implemented as a command in a communication protocol such as SOAP. In a second example, the money request instruction may be an email message. In the second example, the email message may include features that enable receiving party 14 to send the money transfer instruction directly from the email message. For instance, receiving user 14 may send the money transfer instruction to the transaction service provider by entering a PIN number in a text input box included in the email message and clicking a submit button included in the email message.

FIG. 6 is a flowchart illustrating an example operation of referral module 44 in transaction interface module 38 of FIG. 2. In various embodiments, transaction interface module 38 receives a refer user event on transaction account interface 24, referral module 44 identifies parties in contact list 36 who do not have online transaction accounts provided by the transaction service provider (140). Referral module 44 may identify parties in contact list 36 who do not have online transaction accounts in a variety of ways. For example, transaction server system 4 may maintain a list of email addresses of parties that have online transaction accounts. In this example, send money module 40 may identify parties in contact list 36 who have online transaction accounts by comparing the email addresses of the parties in contact list 36 with the email addresses in the list of email addresses maintained by transaction server system 4. In another example, each entry in contact list 36 may include a field that indicates whether a party associated with the entry has an online transaction account provided by the transaction service provider.

Referral module 44 identifies a party or parties in contact list 36 who do not have online transaction accounts provided by the transaction service provider, referral module 44 displays referral interface 27 (142). In various embodiments, referral module 44 may present referral interface 27 in a variety of ways. For instance, referral module 44 may present referral interface 27 as a new window and/or referral module 44 may present referral interface 27 within the body of a new email message.

In various embodiments, referral module 44 presents a list of the identified contacts who do not have online transaction accounts provided by the transaction service provider (144). Referral module 44 may present the list of the identified contacts within referral interface 27.

Referral module 44 receives a recipient selection input that indicates one or more of the parties on the list of the identified contacts (146). For example, the recipient selection input may indicate receiving user 14. Throughout the remainder of the discussion of the example represented in FIG. 6, it is assumed that the recipient selection input indicates receiving user 14. The recipient selection input may result from a variety of actions by sending user 12. For instance, the recipient selection input may constitute a mouse click by sending user 12 on one of the parties who do not have online transaction accounts.

In various embodiments, referral module 44 may receive a sender identification input via referral interface 27 (88). The sender identification input may specify a PIN of sending user 12, an account number of sending user 12, and other information that reliably indicates the identity of sending user 12.

In various embodiments, referral module 44 sends a referral message to the party indicated by the recipient selection input (90). The referral message invites receiving user 14 to register for an online transaction account provided by the transaction service provider. For example, the referral message may be an email message having a body that includes an invitation to register for an online transaction account.

In various embodiments, the referral message includes information that instructs the transaction service provider to electronically transfer money from the online transaction account of sending user 12 to the online transaction account of receiving user 14, for example, in response to receiving user 14 registering for the online transaction account in response to the referral message. For example, sending user 12 may need to pay $150 to receiving user 14, but receiving user 14 does not have an online transaction account. In this example, sending user 12 may click on the refer user icon of transaction account interface 24, select receiving user 14 from the list of contacts who do not have online transaction accounts provided by the transaction service provider, input $150 as a monetary amount input, and send the referral message to receiving user 14. In this example, the referral message may include a link to an account registration webpage provided transaction server system 4. In various embodiments, receiving user 14 selects this link, client device 10 may open a web browser window that contains the account registration webpage. In various embodiments, receiving user 14 may use the account registration webpage to register for an online transaction account. Receiving user 14 successfully registers for the online transaction account and transaction server system 4 may electronically transfer $150 from the online transaction account of sending user 12 to the online transaction account of receiving user 14.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., Alex Nghiem, IT Web Services: A Roadmap for the Enterprise (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQTM (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

It is to be understood that the implementations described herein may be implemented by hardware, software, firmware, middleware, microcode, or any combination thereof. When the systems and/or methods are implemented in software, firmware, middleware or microcode, program code or code segments, they may be stored in a computer-readable storage medium, such as a storage component. A code segment may represent a procedure, a function, a subprogram, a program, a routine, a subroutine, a module, a software package, a class, or any combination of instructions, data structures, or program statements A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, etc.

For a software implementation, the techniques described herein may be implemented with modules (e.g., procedures, functions, and so on) that perform the functions described herein. The software codes and instructions may be stored in computer-readable storage media and executed by processors. The memory unit may be implemented within the processor or external to the processor, in which case it can be communicatively coupled to the processor via various means as is known in the art.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-based method comprising:
displaying, by an email client computer, a transaction account interface of an email client application used by a first party who has a first online transaction account provided by a transaction service provider, wherein the transaction account interface is displayed in a toolbar of an email client application; and
receiving, by the computer, input from a user via the transaction account interface to send money from the first online transaction account to a second online transaction account provided by the transaction service provider.

2. The method of claim 1, further comprising:
in response to the receiving the input, by the computer, identifying a first set of parties, the first set of parties including parties in a contact list associated with the email client application that have online transaction accounts provided by the transaction service provider;
presenting, by the computer, a list of parties in the first set of parties; and
receiving, by the computer, a recipient selection of a second party, the first set of parties comprising the second party.

3. The method of claim 2, further comprising:
receiving, by the computer, a send money event via the transaction account interface;
in response to the receiving the send money event, by the computer, sending a money transfer instruction to the transaction service provider, the money transfer instruction instructing the transaction service provider to electronically transfer money from the first online transaction account to the second online transaction account, wherein the second online transaction account is associated with the second party.

4. The method of claim 2, further comprising:
receiving, by the computer, a request money event on the transaction account interface;
in response to the receiving the request money event, sending, by the computer, a money request instruction to the second party, the money request instruction inviting the second party to send a second money transfer instruction to the transaction service provider, the second money transfer instruction instructing the transaction service provider to transfer money from the second online transaction account the first online transaction account of the first party, wherein the second online transaction account is associated with the second party.

5. The method of claim 4, further comprising, by the computer and in response to the receiving the request money event, receiving a monetary amount input that specifies how much money the first party is requesting the second party to transfer to the first party.

6. The method of claim 4, wherein the sending the money request instruction to the second party comprises sending to the second party an email message that comprises features that enable the second party to send the second money transfer instruction directly from the email message.

7. The method of claim 4, further comprising receiving, by the computer, a memo input that indicates a reason why the first party is sending the money request instruction to the second party, wherein the sending the money request instruction comprises sending the memo input.

8. The method of claim 2, further comprising, by the computer, receiving a monetary amount input that specifies how much money the transaction service provider should transfer from the first online transaction account to the second online transaction account, wherein the sending the money transfer instruction comprises sending a value indicating the amount of money specified by the monetary amount input, wherein the second online transaction account is associated with the second party.

9. The method of claim 2, further comprising receiving, by the computer, sender identification input that includes a personal identification number (PIN) associated with the first party, wherein sending the money transfer instruction comprises sending the PIN.

10. (canceled)

11. The method of claim 1, further comprising:
receiving, by the computer, a refer user event via the transaction account interface;
in response to receiving the refer user event, identifying, by the computer, a second set of parties, the second set of parties including parties in the contact list that do not have online transaction accounts provided by the transaction service provider;
presenting, by the computer, a list of parties in the second set of parties;
receiving, by the computer, a recipient selection event that indicates a second party who is in the second set of parties; and
sending, by the computer, a referral message to the second party that invites the second party to register for an online transaction account provided by the transaction service provider.

12. The method of claim 11, wherein the sending the referral message to the second party comprises sending an email message to the second party.

13. The method of claim 11, wherein the sending the referral message comprises sending information in the referral message that instructs the transaction service provider to electronically transfer money from the first online transaction account to the second online transaction account, wherein the second party registers for the second online transaction account in response to the referral message.

14. An article of manufacture including a non-transitory, tangible computer readable storage medium having instructions stored thereon that, in response to execution by an email client computer, cause the computer-based system to perform operations comprising:
displaying, by the computer, a transaction account interface of an email client application used by a first party who has a first online transaction account provided by a transaction service provider, wherein the transaction account interface is displayed in a toolbar of an email client application; and
receiving, by the computer, input from a user via the transaction account interface to send money from the first online transaction account to a second online transaction account provided by the transaction service provider.

15. The computer-readable storage medium of claim 14, further comprising:
receiving, by the computer, a request money event on the transaction account interface;
in response to the receiving the request money event, receiving, by the computer, a second recipient selection event that indicates a second party who is a member of the first party; and
sending, by the computer, a money request instruction to the second party, the money request instruction inviting the second party to send a second money transfer instruction to the transaction service provider, the second money transfer instruction instructing the transaction service provider to transfer money from the second online transaction account to the first online transaction account, wherein the second online transaction account is associated with the second party.

16. The computer-readable storage medium of claim 14, further comprising:
receiving, by the computer, a refer user event on the transaction account interface;
in response to receiving the refer user event, identifying, by the computer, a second set of parties, the second set of parties including parties in the contact list that do not have online transaction accounts provided by the transaction service provider;
presenting, by the computer, a list of parties in the second set of parties;
receiving, by the computer, a second party selection event that indicates a third party who is in the second set of parties; and
in response to receiving the second party selection event, sending, by the computer, a referral message to the third party that invites the third party to register for an online transaction account provided by the transaction service provider.

17. A system comprising:
an email client processor,
a tangible, non-transitory memory configured to communicate with the processor, the memory having instructions stored thereon that, in response to execution by the processor, cause the processor to perform operations comprising:
displaying, by the processor, a transaction account interface of an email client application used by a first party who has a first online transaction account provided by a transaction service provider, wherein the transaction account interface is displayed in a toolbar of an email client application; and
receiving, by the processor, input from a user via the transaction account interface to send money from the first online transaction account to a second online transaction account provided the transaction service provider.

18. The system of claim 17, further comprising:
in response to receiving the input, automatically identifying a first set of parties, the first set of parties including parties in a contact list associated with the email client application that have online transaction accounts provided by the transaction service provider;
presenting a list of parties in the first set of parties; and,
receiving a recipient selection of a second party, the first set of parties comprising the second party.

19. The system of claim 17, further comprising:
receiving a send money event via the transaction account interface; and
in response to the receiving the send money event, sending a money transfer instruction to the transaction service provider, the money transfer instruction instructing the transaction service provider to electronically transfer money from the first online transaction account to the second online transaction account, wherein the second online transaction account is associated with the second party.

20. The system of claim 18, further comprising:
receiving a request money event on the transaction account interface; and
in response to the receiving the request money event, sending a money request instruction to the second party, the money request instruction inviting the second party to send a second money transfer instruction to the transaction service provider, the second money transfer instruction instructing the transaction service provider to transfer money from the second online transaction account the first online transaction account of the first party, wherein the second online transaction account is associated with the second party.
